(19) United States
(12) Patent Application Publication
(10) Pub. No.: US 2024/0048585 A1
(43) Pub. Date: Feb. 8, 2024

(54) METHODS AND SYSTEMS TO ASSESS CYBER-PHYSICAL RISK

(71) Applicant: Honeywell International Inc., Charlotte, NC (US)

(72) Inventor: Eric KNAPP, Milton, NH (US)

(21) Appl. No.: 18/348,706

(22) Filed: Jul. 7, 2023

Related U.S. Application Data
(60) Provisional application No. 63/370,586, filed on Aug. 5, 2022.

(51) Int. Cl. H04L 9/40

(52) U.S. Cl. CPC H04L 63/1433; H04L 63/1425

(57) ABSTRACT

A method for identifying relationships between physical events occurring in one or more operational technology (OT) components of a system and information technology (IT) infrastructure that controls the system, the method including: collecting performance data from a number of sensors, each sensor associated with an asset in the system; analyzing the collected performance data to generate one or more performance data characteristics; collecting cyber event data related to cyber events occurring in assets of the system and analyzing the cyber event data to identify one or more identified cyber events; and correlating the performance data characteristics against the identified cyber events to determine one or more cyber-physical relationships between the performance data characteristics of the assets in the system and the identified cyber events.

### CROSS-REFERENCE TO RELATED APPLICATION(S)

This application claims the benefit of priority to U.S. Provisional Patent Application No. 63/370,586, filed Aug. 5, 2022, the entirety of which is incorporated by reference herein.

### TECHNICAL FIELD

The present disclosure relates generally to methods and systems to assess cyber-physical risk, and more particularly, to methods and systems to assess cyber-physical risk using a physical consequence of failure and a likelihood of cyber incident.

### BACKGROUND

Security concerns arise at increasing rates in an information and operationally connected environment. Internet of Things (IoT) devices and cyber physical systems (CPS) play a more important role in critical infrastructure, government, and everyday life. Each may include smart networked systems with embedded sensors, processors, and actuators that sense, compute, and interact with the physical world and support real-time, operational performance in critical applications. These devices and systems can be a source of competitive advantage and provide economic opportunities for growth. Simultaneously, CPS and IoT increase cybersecurity risks and enlarge attack surfaces. For example, the consequences of unintentional faults or malicious attacks could severely impact human lives and the environment. Hence, increasing effort and resources should be expended to prevent such consequences.

Adding to the difficulty of the challenge, information technology (IT) and operational technology (OT) systems can often not communicate effectively. IT systems may capture, analyze, and identify events well based on event data in highly specific forms. This event data may consist of application security logs, Windows system events, firewall logs, anomalies identified in network communications, and other precise indicators produced by a specific component. On the other hand, OT assets (including assets typically used in Industrial Automation and Control Systems, ICS, DCS, IoT, IIOT, et al.) increasingly utilize the same computing platforms and operating systems as IT assets but their use is fundamentally different. OT assets operate as a system, using real-time messaging and proprietary logic to operate with varying degrees of autonomy up to and including fully automated closed-loop systems. This difference in employment between the system types can create difficulties when identifying cyber-physical attacks on OT systems, which may be less recognizable from an OT lens.

Further, current systems and methods do not consider assessing an overall cyber-physical risk, which risk includes a physical consequence of failure (e.g., a predicted extent of damage to infrastructure or OT systems) in the case of a successful attack and a likelihood of a cyber-physical incident. Existing systems that allege to identify cybersecurity risk may be limited to an assessment of traditional event data from computing systems and using such event data in a more traditional “IT” manner. Additionally, systems that allege to identify OT cybersecurity risk may be limited to assessing risk of traditional computing systems that are deployed within an industrial or “OT” environment, and may not extend to factors of industrial automation and operational control. Such an assessment could be based on improved fidelity with respect to cyber-physical attacks on OT and IT infrastructure as discussed above and thus provide a clearer assessment as to overall risk. The assessment could be made even more useful using highly accurate simulations of various OT systems in the form of digital twins. Accordingly, systems and methods for both correlating unrelated data sets from disparate systems to detect cyber-physical attack patterns and systems and methods for using predictive simulations for identification of potential cyber-physical risk exposures based on the correlated data sets may be required.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

In one embodiment, a method for identifying relationships between physical events occurring in one or more operational technology (OT) components of a system and information technology (IT) infrastructure that controls the system, includes: collecting performance data from a number of sensors, each sensor associated with an asset in the system; analyzing the collected performance data to generate one or more performance data characteristics; collecting cyber event data related to cyber events occurring in assets of the system and analyzing the cyber event data to identify one or more identified cyber events; and correlating the performance data characteristics against the identified cyber events to determine one or more cyber-physical relationships between the performance data characteristics of the assets in the system and the identified cyber events.

In another embodiment, a method of assessing cyber-physical risk includes: collecting performance data from a number of sensors, each sensor associated with an asset in an industrial control system and analyzing the performance data to generate one or more performance data characteristics; collecting cyber event data related to cyber events occurring in assets of the system and analyzing the cyber event data to identify one or more identified cyber events; correlating the performance data characteristics against the identified cyber events to determine one or more cyber-physical relationships between the performance data characteristics of the assets in the system and the identified cyber events; identifying cyber-physical threats based on the analyzed performance data and the analyzed cyber event data; determining a likelihood of a cyber-physical incident based on the identified cyber-physical threat; generating one or more digital object models of physical assets in the systems; performing one or more simulations to predict one or more failure events using the one or more digital object models; measuring a simulated physical consequence of the one or more predicted failure events; and comparing the physical consequences of the one or more predicted failure events with the likelihood of a cyber-physical incident to assess a risk of a cyber-physical event.

In yet another embodiment, a method of assessing a risk of a cyber-physical threat, includes: generating one or more digital object models of physical assets in an industrial control system, each digital object model being a virtual representation of the physical asset that spans a lifecycle of the physical asset and is updated from real-time data collected at one or more sensors configured to sense one or more aspects of the physical asset; performing one or more continuous simulations on the industrial control system using the digital object models to predict one or more failure events; measuring a simulated physical consequence of the one or more predicted failure events based on input from an enterprise performance management software tool; and comparing the physical consequences of the one or more predicted failure events with a likelihood of a cyber-physical incident to assess an overall risk of a cyber-physical event.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

Embodiments of the disclosure will now be described, by way of example only, with reference to the accompanying drawings in which:

FIG. 1 illustrates an example industrial process control and automation system, according to embodiments described herein.

FIG. 2 further illustrates the industrial process control and automation system of FIG. 1 in the context of other industrial process control and automation systems.

FIG. 3 illustrates a process for utilizing the industrial process control and automation system of FIG. 1.

FIG. 4 illustrates another process for utilizing the industrial process control and automation system of FIG. 1.

### DETAILED DESCRIPTION

The following embodiments describe methods and systems to assess cyber-physical risk, and more particularly, to methods and systems to assess cyber-physical risk using a physical consequence of failure and a likelihood of cyber incident.

One line of effort that could help to address the problems mentioned above and to prevent faults and attacks is nested in careful analytics. Cybersecurity analytics relies heavily on the collection, correlation, and analysis of security event data produced by various assets within the IT infrastructure. As mentioned above, “event Data” might consist of application security logs and other precise indicators produced by a specific hardware or software component within a greater system. Most cybersecurity software products are focused on new ways of analyzing this event data using any number of methods from simple rule-based taxonomies to advanced AI and machine learning applications. However, they all generally rely on the availability of security event data.

As briefly alluded to above, OT assets increasingly utilize the same computing platforms and operating systems as IT assets. However, the way OT assets are used is often fundamentally different. OT assets operate as a system, using real-time messaging and proprietary logic to operate with varying degrees of autonomy up to and including fully automated closed-loop systems.

OT assets may produce a subset of security events, originating from the COTS computing and operating systems (such as Windows event logs). Similarly, third party security solutions that monitor networks or endpoints for security purposes might be able to produce a subset of security event data from OT systems. However, the OT systems themselves do not produce typical security events, and therefore the software products available on the market today are incompatible with OT at a system level.

Event data from OT systems might comprise performance metrics operational alarms and various forms of process control events—all highly relevant data points that are event-driven. However, because the function of OT systems and IT assets differ considerably in content and format, these data points (referred to hereafter as “OT events” for simplicity) are often not understood by IT cybersecurity solutions, and therefore OT events are often absent from the analytics provided by IT security tools, systems, and services in use today. OT systems are focused on physical properties, and therefore OT events are also focused on physical properties. IT systems are focused on digital properties, and therefore IT events are also focused on digital properties.

This presents a problem. The manipulation of physical properties using digital methods, known in the industry as “cyber-physical threats,” is something that can be invisible to current cybersecurity solutions. Customers looking to protect their OT systems, even if they invest in the newest IT security solutions on the market today, are not adequately analyzing security event data in a way that is truly relevant to industrial automation and control. As a result, there is no way to adequately monitor, analyze, or mitigate cyber-physical risk.

Providing methods to translate OT events into something consumable by commercial IT security solutions may support the ongoing convergence of IT and OT systems, by “connecting the dots” between IT and OT systems in such a way that cyber-physical risks can be identified, monitored, and analyzed.

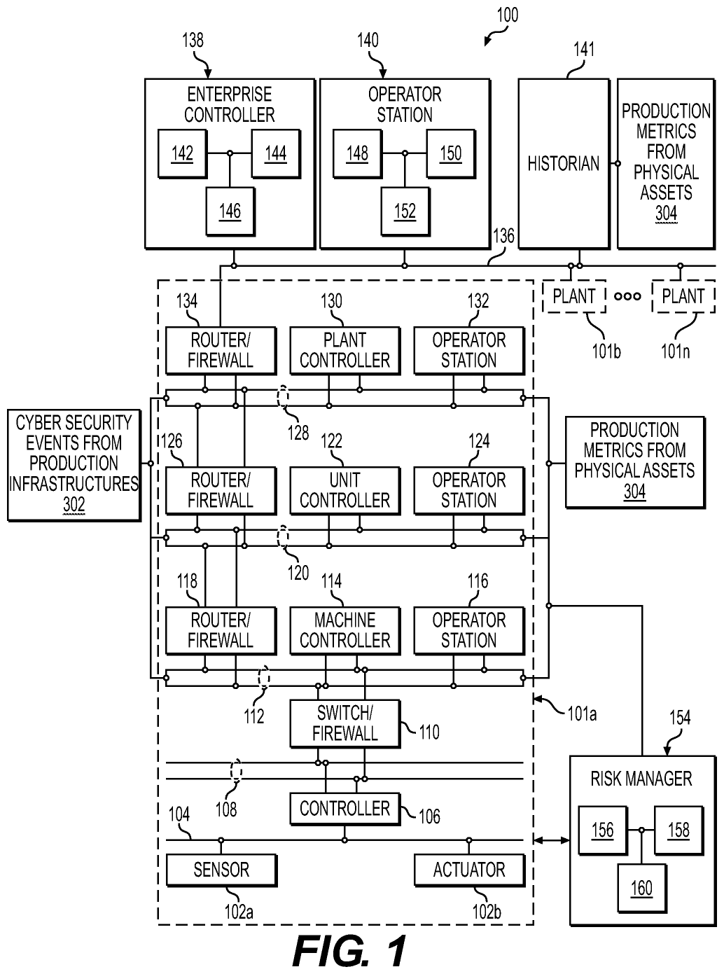

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple facilities 101a, 101b . . . 101n. Each facility 101a-101n represents one or more processing facilities (or one or more portions thereof), such as one or more manufacturing facilities, treatment plants, or other industrial facilities for carrying out some industrial process. In general, each facility 101a-101n may implement one or more processes and can individually or collectively be referred to as a process system. A process system generally represents any system or portion thereof configured to process one or more products or other materials in some manner.

In FIG. 1, the system 100 is implemented using various levels of process control. “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, flow rate, acidity, concentration, etc. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

“Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

“Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

“Level 3” may include one or more unit-level controllers 122 coupled to the networks 120. Each unit-level controller 122 is typically associated with a unit in a process system, which represents a collection of different machines 10 operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

“Level 4” may include one or more facility-level “plant controllers” 130 coupled to the networks 128. Each facility-level plant controller 130 is typically associated with one of the facilities 101a-101n, which may include one or more process units that implement the same, similar, or different processes. The facility-level plant controllers 130 perform various functions to support the operation and control of components in the lower levels. As particular examples, the facility-level plant controller 130 could execute one or more manufacturing execution system (MES) applications, scheduling applications, or other or additional facility or process control applications. Each of the facility-level plant controllers 130 includes any suitable structure for providing access to, control of, or operations related to one or more process units in a process facility. Each of the facility-level plant controllers 130 could, for example, represent a server computing device running a MICROSOFT WINDOWS operating system.

Access to the facility-level plant controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

“Level 5” may include one or more enterprise-level controllers 138 coupled to the network 136. Each enterprise-level controller 138 is typically able to perform planning operations for multiple facilities 101a-101n and to control various aspects of the facilities 101a-101n. The enterprise-level controllers 138 can also perform various functions to support the operation and control of components in the facilities 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more facilities. Each of the enterprise-level controllers 138 could, for example, represent a server computing device running a MICROSOFT WINDOWS operating system. In this document, the term “enterprise” refers to an organization having one or more facilities or other processing facilities to be managed. Note that if a single facility 101a is to be managed, the functionality of the enterprise-level controller 138 could be incorporated into the facility-level controller 130.

Access to the enterprise-level controllers 138 may be provided by one or more operator stations 140. Each of the operator stations 140 includes any suitable structure for 10 supporting user access and control of one or more components in the system 100. Each of the operator stations 140 could, for example, represent a computing device running a MICROSOFT WINDOWS operating system.

Various levels of a systems model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106,114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116,124,132,140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers.

As noted above, cyber-security is of increasing concern with respect to industrial process control and automation systems. Unaddressed security vulnerabilities in any of the components in the system 100 could be exploited by attackers to disrupt operations or cause unsafe conditions in an industrial facility. However, in many instances, operators do not have a complete understanding or inventory of all equipment running at a particular industrial site. As a result, it is often difficult to quickly determine potential sources of risk to a control and automation system.

This disclosure recognizes a need for a solution that understands potential vulnerabilities in various systems, prioritizes the vulnerabilities based on risk to an overall system, and guides a user to mitigate the vulnerabilities. Moreover, a quantification of “cyber-security risk” has little value unless it both aligns with established organizational risk policies and aligns with recognized risk methodologies and standards. In other words, additional context for a risk score is often needed in order to effectively portray what a risk means to an organization.

This may be accomplished (among other ways) using a risk manager 154. Among other things, the risk manager 154 supports a technique for tying risk analysis to common risk methodologies and risk levels. The risk manager 154 includes any suitable structure that supports automatic handling of cyber-security risk events. Here, the risk manager 154 includes one or more processing devices 156; one or more memories 158 for storing instructions and data used, generated, or collected by the processing device(s) 156; and at least one network interface 160. Each processing device 156 could represent a microprocessor, microcontroller, digital signal process, field programmable gate array, application specific integrated circuit, or discrete logic. Each memory 158 could represent a volatile or non-volatile storage and retrieval device, such as a random access memory or Flash memory. Each network interface 160 could represent an Ethernet interface, wireless transceiver, or other device facilitating external communication. The functionality of the risk manager 154 could be implemented using any suitable hardware or a combination of hardware and software/firmware instructions.

In some embodiments, how risk matters to an organization is determined through the use of two threshold values: risk appetite and risk tolerance. These thresholds dictate when an organization is capable of absorbing risk and when action needs to be taken. For example, if below an organization's risk appetite, a risk is acceptable. If above the risk appetite, the risk should be addressed. The risk tolerance is a higher threshold that determines when a risk has become dangerously high; action should still be taken but now with increased urgency.

Within the risk manager 154, risk appetite and risk tolerance can denote user-configurable parameters that may be used as the thresholds for risk item notifications, and these can be defined for each type or classification of risk. In some embodiments, the values of risk appetite and risk tolerance are used as threshold points for alarming and notification. When below the risk appetite, items are of low priority. When above the risk appetite but below the risk tolerance, the items become warnings. Above the risk tolerance, the items become alerts.

Although FIG. 1 illustrates one example of an industrial process control and automation system 100, FIG. 1 should be interpreted to include and encompass numerous variations. For example, a control and automation system could include any number of sensors, actuators, controllers, servers, operator stations, networks, risk managers, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which the functions of the risk manager 154 can be used. This functionality can be used in any other suitable device or system.

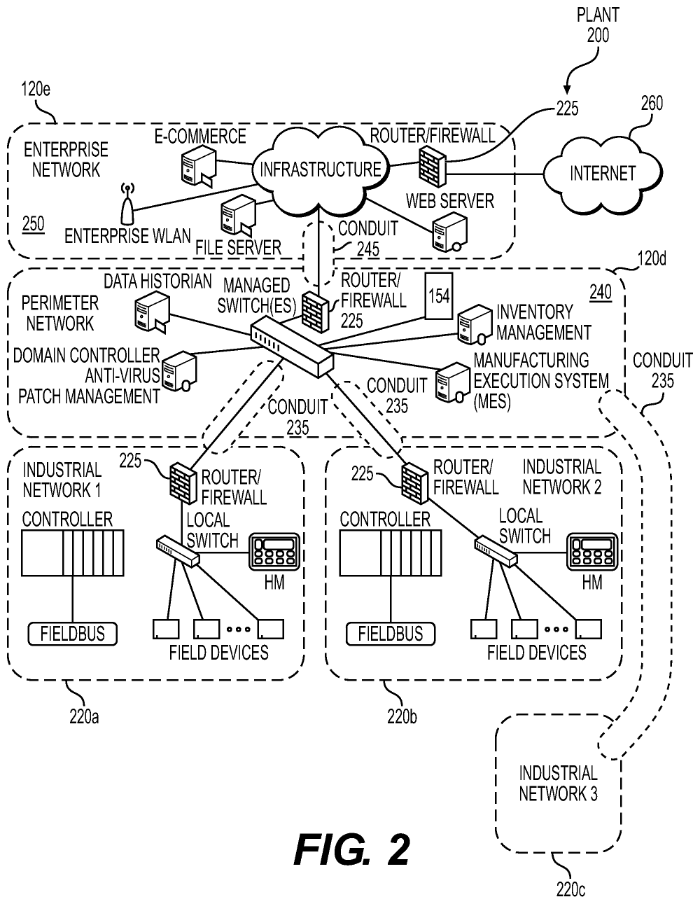

FIG. 2 shows an example industrial plant 200 divided into a plurality of security zones, where each security zone shown has its own router or firewall (router/firewall) 225. Industrial plant 200 is shown including industrial network 1 220a, industrial network 2 220b, industrial network 3 220c. Each may have its own network of devices (which may correspond to network 104 of FIG. 1, for example). Depending on the plant setup, there may be devices from a plant-level 120d within the individual industrial networks 220a, 220b, and 220c. In the example industrial plant 200 shown in FIG. 2, the human machine interfaces (HMI) are represented within industrial networks 220a, 220b and 220c. Generally an HMI is performed through an operator console station of some kind, which may be part of plant-level 120d. Also, although not shown in FIG. 2, there are generally servers used to provide information for those displays and provide access to controllers.

Industrial network 1 220a, industrial network 2 220b, and industrial network 3 220c are each connected by a conduit 235 to the plant-level 120d shown as an industrial perimeter network (perimeter network) 240 which is coupled by another conduit 245 to the business level 120e shown as an enterprise network 250, which is coupled to the Internet 260 (e.g., through a cloud network or other network). The plant-level 120d shown as a perimeter network is a physical or logical subnetwork that contains and exposes an organization's external-facing services to a larger and untrusted network. The system 100 may further include the risk manager 154, which may be, for example, part of the plant-level 120d.

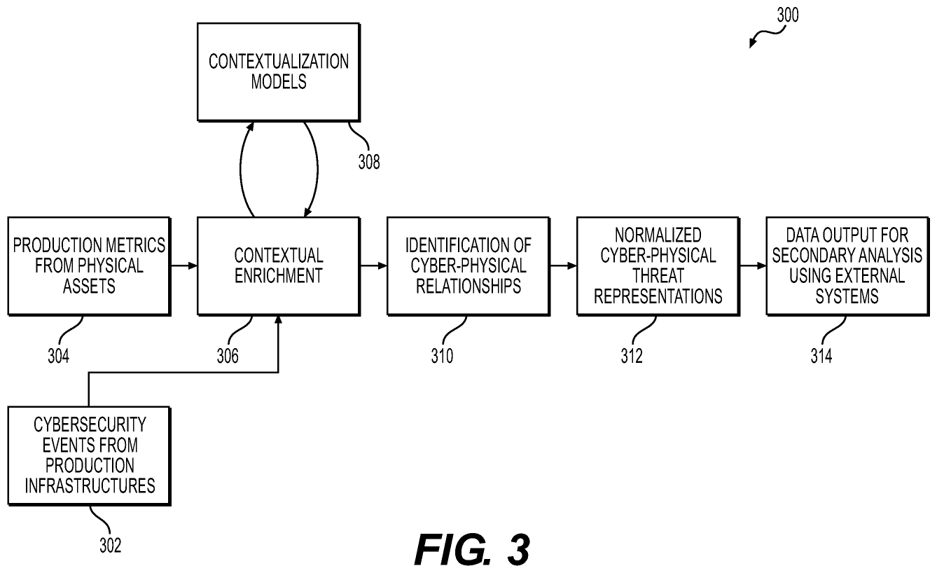

FIG. 3 illustrates a method 300 of collecting unstructured and disparate data with little or no common data points, enriching that data so as to provide common data points and cross-domain context, and then analyzing the newly contextualized data to find patterns indicative of a cyber-physical threat.

The method includes collecting unstructured and disparate data for analysis. At step 302, cybersecurity event data could be collected from a network infrastructure such as the system 100 of FIG. 1. For example, cybersecurity event data may be collected from one or more of the multiple facilities 101a-101n. The cybersecurity event data could be collected using existing event logging mechanisms (e.g., syslog, WMI, etc.) The cybersecurity event data may include data associated with events such as, for example, illicit access, illicit change, or illicit damage to computing device(s), sensor(s), actuator(s), or other components of the system 100 of FIG. 1. Events may include, for example, various types of cyber-security attacks that could be launched against an organization or its equipment, such as the installation of malware or the illicit control of processing equipment. Events may also include, for example, attempted identification or exploitation of vulnerabilities such as networked equipment that could be exploited, such as missing or outdated antivirus software, misconfigured security settings, or weak or misconfigured firewalls. Event data may further include operational alarms and various forms of process control events.

At step 304, production metrics could be collected from physical assets such as the physical assets in the multiple facilities 101a-101n, which production metrics may be measured, at least in part, by the sensors 102a. Production metrics may include, for example, product or process volume, product through-put, product or process quality, operating hours, and the like. Which production metrics are collected may be selectable by a user of the system 100. In some embodiments, the system 100 may include one or more subsystems for determining the best metrics to collect, such as one more machine learning algorithms configured to analyze production metrics and recommend or select performance metrics.

At step 306, a mechanism to determine context between the two disparate sources of data generated and received at steps 302 and 304 could be applied to enrich the source data with context. A variety of contextualization models could be applied at step 308 and the contextualized data can be selectively or continuously contextualized based on the variety of contextualization models as indicated by the feedback between steps 306 and 308.

In some embodiments, the contextualization could be applied using, for example, a security information and event management (SIEM) platform. Security events may be enriched, for example, with contextual information from user directories, asset inventory tools (such as configuration management database (CMDB)), geolocation tools, third party threat intelligence databases, and other sources. In other embodiments, for example, the contextualization could be applied using database(s) of known assets, such as software components of a distributed control system (e.g., the system 100) that provide asset management. In other embodiments, contextualization may be determined using machine learning algorithms to identify common patterns and anomalies between event sources. In other exemplary embodiments, contextualization may be determined using machine learning algorithms to identify assets that are connected to both IT and OT systems. In other exemplary embodiments, contextualization could be configured manually by the end user. In other exemplary embodiments, the necessary contextualization could be provided by meta data provided within the source event data. These exemplary contextualization models and others may be practiced together or separately in any combination over various series of contextualization. Each contextualization series may provide additional insight or further compound on the contextualization of preceding and subsequent contextualization.

In some embodiments, contextual enrichment may include collecting performance data for all assets in a particular asset class across an enterprise (e.g., all the hydraulic pumps in a water treatment plant) or for all assets which otherwise have a common characteristic, and the performance data for all the assets in that asset class or with the common characteristic across the enterprise is compared with respect to a particular class or type of cyber event. For example, it may be beneficial to examine the performance of a hydraulic pump in a water treatment plant with respect to a denial of service attack against the performance of all other hydraulic pumps in similar water treatment plants with respect to a similar denial of service attack. In some embodiments, the performance data may include one or more key performance indicators, such as, for example, key performance indicators used to track the performance of a plant or other industrial site in an enterprise management system, such as, for example, Honeywell's EPM FORGE system. The key performance indicators may include, for example, metrics such as throughput, profitability, number of machine hours, etc.

Non-limiting examples of contextual information used for security data enrichment may include identity context (such as identity and access management (IAM) systems, directories, enterprise resource planning (ERP) systems, and Active Directory (AD)), asset information (such as configuration management database (CMDB)), access privileges (such as AD group memberships), non-technical feeds (such as background checks and badge data), vulnerability context (such as scan reports), social and online context (such as social media and chat), network maps and geolocation (such as internal network classification for cross border analytics), and other contextual information.

Once the contextual enrichment has been applied, the cyber-physical relationship(s) between the source event data (step 302 and step 304) are determined at step 310. This could be the result of correlations between the applied contextualization from step 308. In one embodiment, the relationships could be identified using machine learning algorithms. In one embodiment, the relationships could be manually configured by a human administrator of the system.

At step 312, the relationships between the source event data are normalized. Normalization may produce a cyber-physical threat representation, which identify areas where cybersecurity event data can be linked to the physical outcomes of industrial process control. The cyber-physical representations, including the original event data, contextual enrichment data, and cyber-physical determination data, are then packaged into an industry standard data messaging format (syslog, JSON, XML, etc.), so that the cyber-physical representations can maintain compatibility with existing event management tools and services. Normalization of the relationships may occur using, for example, one or more primary factors, which primary factors may include, for example: source type, asset identification, risk indicator properties (data bounds detected for properties based on the common information model), and risk index component contribution.

According to one or more embodiments, normalization may include: (1) identifying data source categories, aligning data source categories with a standard taxonomy of data sources and assigning a primary type (and (optionally) a secondary type); (2) creating a normalization function for severity values, which may be produced by the data source, which can transform data from source format into a normalized scale on a selected scale, for example, a scale of 0-3 per data source, although many other scales are possible; and (3) assigning a weight to each data source category, which weight ay apply regardless of data source. Such steps may produce normalized data related to an event that captures activity relative to categories of data sources such as malware, anti-virus (AV), network intrusion protection system (NIPS), network firewall(s), etc.

At step 314, the cyber-physical threat representations may be output for secondary analysis using external systems, such as, for example, existing event management tools and services. In some embodiments, the threat representations may be displayed, for example, on a screen of a device (e.g., depicted as a dashboard), which may indicate various alerts and other notifications to a user of the system 100.

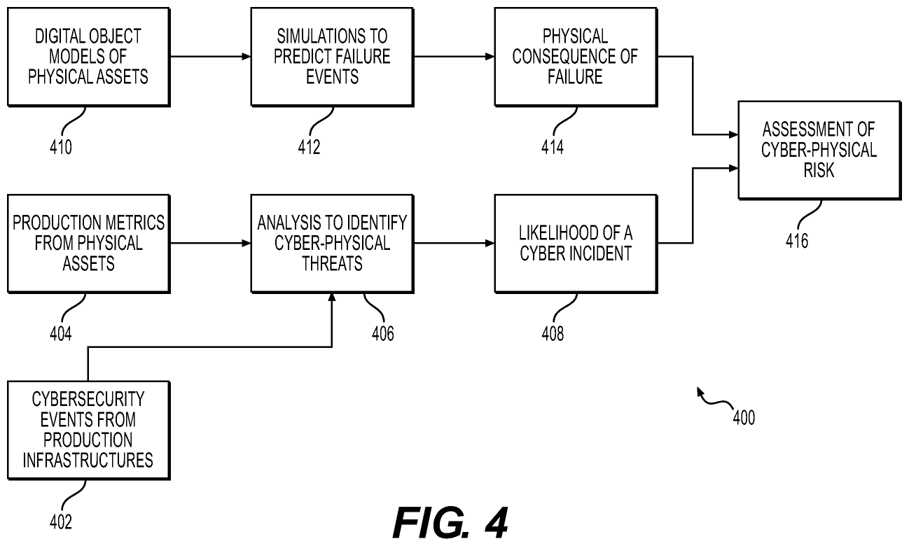

FIG. 4 shows a method 400 of using a digital twin to simulate a predicted failure event in order to assess cyber-physical risk in an OT/IT environment, such as the system 100. The method 400 includes two general paths of information processing to determine the assessment of cyber-physical risk. In a first prong, the method 400 uses an analysis of cyber-physical threats (e.g., steps 410, 412), which may be conducted similarly to the analysis described with respect to FIG. 3 herein, to determine a likelihood of a cyber incident. In a second prong, the method 400 may use one or more digital twins to simulate failures (e.g., step 406) based on cyber-physical attacks to determine the physical consequences of such failure (e.g., step 408) on a system (e.g., the system 100). The physical consequence of failure may be compared with the likelihood of the cyber-physical incident to determine the overall assessment of the cyber-physical risk.

Starting with the first prong, at step 402, cybersecurity event data could be collected from a network infrastructure such as the system 100 of FIG. 1. For example, cybersecurity event data may be collected from one or more of the multiple facilities 101a-101n. The cybersecurity event data could be collected using existing event logging mechanisms (e.g., syslog, WMI, etc.) The cybersecurity event data may include data associated with events such as, for example, illicit access, illicit change, or illicit damage to computing device(s), sensor(s), actuator(s), or other components of the system 100 of FIG. 1. Events may include, for example, various types of cyber-security attacks that could be launched against an organization or its equipment, such as the installation of malware or the illicit control of processing equipment. Events may also include, for example, attempted identification or exploitation of vulnerabilities such as networked equipment that could be exploited, such as missing or outdated antivirus software, misconfigured security settings, or weak or misconfigured firewalls. Event data may further include operational alarms and various forms of process control events.

At step 404, the production metrics could be collected from physical assets such as the physical assets in the multiple facilities 101a-101n, which production metrics may be measured, at least in part, by the sensors 102a. Production metrics may include, for example, product or process volume, product through-put, product or process quality, operating hours, and the like. Which production metrics are collected may be selectable by a user of the system 100. In some embodiments, the system 100 may include one or more subsystems for determining the best metrics to collect, such as one more machine learning algorithms configured to analyze production metrics and recommend or select performance metrics.

At step 406, an analysis may be conducted to identify cyber physical threats. The analysis may be based on, at least in part, correlation of data between the performance data characteristics and the identified cyber events, which may determine one or more cyber-physical relationships between the performance data characteristics of the assets in the system and the identified cyber events. In some embodiments, the analysis may be based, at least in part, on contextual enrichment of the collected data.

At step 408, an analysis of the likelihood of cyber incidents may be conducted. The likelihood of cyber events may be based on a number of factors. For example, the likelihood of a cyber event may be based on threats identified (e.g., at step 406), the level of vulnerabilities identified within the system 100, and the value to an adversary of achieving success with a cyber event. For example, in the case of data theft or denial of service for a particular informational asset or physical asset, the adversary may find a given value for stealing such data or interrupting service. The likelihood of cyber incident may be calculated in some examples as the (threats identified)×(level of vulnerabilities)×(value to the adversary), with the magnitude of each factor increasing the likelihood of cyber incident.

Starting with the second prong, at step 410, the system 100 may be used to model one or more of its cyber or physical assets as digital objects. The digital physical object may be referred to as, for example, a cyber-physical digital twin. The digital cyber object (e.g., software, etc.) may be referred to as a cyber-cyber digital twin. The digital twin may be, for example, a virtual representation of an object or subsystem of the system 100. The digital twin may span the lifecycle of the object or subsystem and may be updated from time to time with real-time data from the object or subsystem. The digital twin may use, for example, simulation and/or machine learning to model the physical asset. The sensors 102a of the system 100 may be mapped onto the digital twin and the digital twin may represent real-time, sensor-based data about the physical asset to users. In some embodiments, the digital twin may be formed, at least in part, based on predictive maintenance models of the physical asset the digital twin is generated to simulate.

Predictive maintenance models may provide a strategy for balancing corrective and preventive maintenance through the use of sensed parameters and analysis of sensed data using algorithms (e.g., ML algorithms) to perform “just in time” maintenance operations. Parts and systems may be replaced when they are within a window of failure and the effects of failure may be measured system-wide such that effects of the failure of one system or component within an overarching system can be determined on a system-wide basis. The predictive maintenance models may thus be a good tool for predicting overall consequence to a system or aspects of a system based on failure of one or more components thereof. Enterprise performance management (EPM) systems (such as Honeywell's EPM FORGE) may have tools for determining accurate predictive maintenance models, and hence, may serve as a good basis for input into calculations of overall consequences of system failure.

At step 412, the digital twin and associated data may be used to simulate events, which may be used to predict failure events. The simulations may be based on possible cyber-physical attacks on the assets which the digital twins represent. The regular transfer of information between a digital twin and its corresponding physical asset may makes real-time simulation possible. This may increase the accuracy of predictive analytical models and the management and monitoring policies of enterprises. Using the digital twins, the system 100 may be simulated under any type of cyber-physical, cyber-cyber, or hybrid attack such as zero-day, eavesdropping, denial of service, data inject, replay, and side-channel attacks which may take the form of simulated malware, ransomware, botnets, or other simulated forms.

At step 414, based on the simulations using the digital twins, the system 100 may determine a physical consequence of failure of the physical assets. In some embodiments, the physical consequence of failure may be based, at least in part, on predictive maintenance models, which may provide a system-wide scope of consequence to the system and its various subsystems and components based on failure of one or more aspects in the system. In certain instances, cyber-physical attacks may lead to partial or complete failure of particular components. Meanwhile, the failure of these components may be simulated in predictive maintenance models of the system. Hence, predictive maintenance models may provide sufficient background and detailed analysis capabilities for determining overall consequence of one or more components or subsystems to the overall system.

At step 416, an assessment of cyber-physical risk may be conducted based on the physical consequences of failure and the likelihood of experiencing a cyber-physical event. The assessment may be expressed, for example, as a function of likelihood and impact (f(likelihood, impact)). The likelihood and impact may be expressed in a threat matrix, for example, with the highest likelihood of incident being at the top of a y-axis and the highest impact being at the highest degree of an x-axis. In some embodiments, the assessment of cyber-physical risks may be used to take one or more actions within the system 100, for example, to increase a level of firewall between one or more components of the system 100 or to communicatively isolate one or more components or subsystems within the system 100.

It should now be understood that security concerns may arise at increasing rates in information and operationally connected environments due to the proliferation of IoT devices and the cyber-physical systems, to which the IoT devices may connect. Embedded sensors, processors, and actuators that sense, compute, and interact with the physical world and support real-time, operational performance in critical applications may be used to perform industrial processes, improving productivity and economic conditions. However, because of the inherent threat to these interconnected systems, vigilant assessment of risks posed by threats and vulnerabilities within these systems is required. Collecting, analyzing, and relating simultaneously-generated and correlated data from OT and IT infrastructures within these systems can help recognize and identify these threats. Subsequently, identified threats can be used to determine an overall likelihood of similar future threats, which can be compared with detailed predictions of consequences of these threats. These detailed predicted consequences can be based on virtual simulations using digital twins. Based on the scope of consequences and the likelihood of cyber events, a complete analysis of threat to a system, such as an industrial control system, can be determined.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

What is claimed is:

1. A method for identifying relationships between physical events occurring in one or more operational technology (OT) components of a system and information technology (IT) infrastructure that controls the system, the method comprising:
collecting performance data from a number of sensors, each sensor associated with an asset in the system;
analyzing the collected performance data to generate one or more performance data characteristics;
collecting cyber event data related to cyber events occurring in assets of the system and analyzing the cyber event data to identify one or more identified cyber events; and
correlating the performance data characteristics against the identified cyber events to determine one or more cyber-physical relationships between the performance data characteristics of the assets in the system and the identified cyber events.

2. The method of claim 1, wherein one or more of the collected performance data and the collected cyber event data is contextually enriched using one or more of a security information and event management platform, contextual information from user directories, asset inventory tools, geolocation tools, third party threat intelligence databases, software components of a distributed control system, machine learning algorithms, and manual configurations.

3. The method of claim 1, wherein contextual enrichment comprises collecting performance data for all assets in an asset class across an enterprise, and the performance data for all the assets in the asset class across the enterprise is compared with respect to a class of cyber event.

4. The method of claim 2, further comprising normalizing the determined cyber-physical relationships to a common cyber-physical relationship model.

5. The method of claim 1, further comprising outputting data for secondary analysis using external systems.

6. The method of claim 4, wherein the performance data includes data that is used to form one or more key performance indicators for tracking an overall performance of an industrial facility.

7. The method of claim 4, further comprising identifying a likelihood of cyber incident based on an identification of assets, threats, and vulnerabilities within the system.

8. The method of claim 4, wherein the cyber event data is collected from network infrastructure using pre-existing event logging mechanisms.

9. The method of claim 8, wherein the cyber event data includes data related to events comprising: illicit access including installation of malware and illicit control of processing equipment, attempted identification or exploitation of vulnerabilities including missing or outdated antivirus software, misconfigured security settings, or weak or misconfigured firewalls, illicit change, or illicit damage to assets which comprise: computing devices, sensors, and actuators.

10. The method of claim 4, further comprising identifying cyber-physical threats based on the analyzed performance data and the analyzed cyber event data.

11. The method of claim 10, further comprising diagnosing a cyber-physical event based on an identified cyber-physical threat and real-time data collected from a digital twin of a physical asset in the system.

12. A method of assessing cyber-physical risk comprising:
collecting performance data from a number of sensors, each sensor associated with an asset in an industrial control system and analyzing the performance data to generate one or more performance data characteristics;
collecting cyber event data related to cyber events occurring in assets of the system and analyzing the cyber event data to identify one or more identified cyber events;
correlating the performance data characteristics against the identified cyber events to determine one or more cyber-physical relationships between the performance data characteristics of the assets in the system and the identified cyber events;
identifying cyber-physical threats based on the analyzed performance data and the analyzed cyber event data;
determining a likelihood of a cyber-physical incident based on the identified cyber-physical threat;
generating one or more digital object models of physical assets in the systems;
performing one or more simulations to predict one or more failure events using the one or more digital object models;
measuring a simulated physical consequence of the one or more predicted failure events;
comparing the physical consequences of the one or more predicted failure events with the likelihood of a cyber-physical incident to assess a risk of a cyber-physical event.

13. The method of claim 12, wherein one or more of the one or more digital object models is a virtual representation of the physical asset that spans a lifecycle of the physical asset and is updated from real-time data collected at the physical asset.

14. The method of claim 13, wherein the simulated physical consequence of the one or more predicted failure events is measured in real time based on the real-time data collected at the physical asset.

15. The method of claim 12, wherein collecting performance data includes collecting data related to performance metrics, operational alarms, and process control events in the industrial control system.

16. The method of claim 12, wherein one or more of the collected performance data and the collected cyber event data is contextually enriched using one or more of a security information and event management platform, contextual information from user directories, asset inventory tools, geolocation tools, third party threat intelligence databases, software components of a distributed control system, machine learning algorithms, and manual configurations.

17. A method of assessing a risk of a cyber-physical threat, comprising:
generating one or more digital object models of physical assets in an industrial control system, each digital object model being a virtual representation of the physical asset that spans a lifecycle of the physical asset and is updated from real-time data collected at one or more sensors configured to sense one or more aspects of the physical asset;
performing one or more continuous simulations on the industrial control system using the digital object models to predict one or more failure events;
measuring a simulated physical consequence of the one or more predicted failure events based on input from an enterprise performance management software tool;
comparing the physical consequences of the one or more predicted failure events with a likelihood of a cyber-physical incident to assess an overall risk of a cyber-physical event.

18. The method of claim 17, wherein the simulated physical consequence of the one or more predicted failure events is measured in real time based on the real-time data collected at the physical asset and calculated based on one or more predictive maintenance models.

19. The method of claim 17, wherein the a likelihood of a cyber-physical incident is determined based on correlated performance data characteristics and identified cyber events, which are correlated to determine one or more cyber-physical relationships between the performance data characteristics of assets in the industrial control system and identified cyber events in the industrial control system.

20. The method of claim 19, wherein the performance data characteristics are based on performance data collected from a number of sensors, each sensor associated with an asset in the industrial control system.
